(19) United States
(12) Patent Application Publication
(10) Pub. No.: US 2005/0216364 A1
(43) Pub. Date: Sep. 29, 2005

(54) System and method for a buyer driven transaction

(76) Inventors: Allen P. Jurisic, Ontario (CA); David Ublansky, Winsor (CA)

Correspondence Address: LITMAN LAW OFFICES, LTD, PO BOX 15035, CRYSTAL CITY STATION, ARLINGTON, VA, 22215, US

(21) Appl. No.: 11/089,363

(22) Filed: Mar. 25, 2005

Related U.S. Application Data
(60) Provisional application No. 60/556,077, filed on Mar. 25, 2004.

(51) Int. Cl. G06F 17/60

(52) U.S. Cl. 705/26

(57) ABSTRACT

The system and method for a buyer driven transaction includes a Web site where buyers can post ads for goods or services that the buyer wishes to purchase and specify a price the buyer is willing to pay for the goods or services. Sellers can browse the posted buyer ads and tender offers, and the system also includes a database in which sellers can post an inventory of goods or services and a price at which the sellers are willing to sell. When a buyer posts an ad, a search engine searches the database to match a seller with the buyer, and matches are displayed to the buyer so that the buyer can make an offer to the seller. Alternatively, a buyer can browse the seller database and make an offer for merchandise listed in the database.

### CROSS-REFERENCE TO RELATED APPLICATION

This application claims the benefit of U.S. Provisional Patent Application Ser. No. 60/556,077, filed Mar. 25, 2004.

### BACKGROUND OF THE INVENTION

1. Field of the Invention

The present invention relates to a computerized method of buying and selling products and services. More particularly, the invention is a computerized system and method for a buyer driven transaction.

2. Description of the Related Art

The Internet has been a phenomenon as far as facilitating the way people do business. Early in its development, people were using the Internet as a bidding medium to bid on various items and even to bid on various services. Several computer network-based systems have been proposed for sales transactions, including some that are initiated by a buyer indicating a desire to purchase particular goods and services, but none have proven to be entirely satisfactory. Some representative systems and methods are as follows.

United States Patent Publication No. 2001/0056412, published on Dec. 27, 2001, describes a transaction intermediary system and method with a negotiation capability to promote the trading of goods or services between buyers and sellers for achieving buyer driven transactions, including transactions resulting from negotiation requests initiated by buyers. The system receives first and second offers of data of goods and services provided by sellers where the second offer of data of goods and services has conditions more beneficial to buyers in price or quality than the first offer of data and goods.

United States Patent Publication No. 2002/0023042, published on Feb. 21, 2002, discloses a system and method that searches for, and notifies sellers of, a potential buyer for goods and services offered for sale by the sellers. Sellers can generate offers through the system, and the buyer and all prospective sellers see the products for sale and the best offers, thereby allowing sellers to offer a lower price and/or better terms.

United States Patent Publication No. 2002/0010636, published on Jan. 24, 2002, teaches a system and method of connecting buyers and sellers via a network where neither party needs to incur significant search costs to locate the other, and the search requirement of connecting a buyer and a seller can be decreased, eliminated or automated by the use of a controller that sends the buyer's request to sellers who have previously indicated a willingness to accept such offers.

United States Patent Publication No. 2002/0065760, published on May 30, 2002, describes a computer system and method in which a manufacturer or service provider may communicate goods or services which are available for bidding by bidders. The bids received from the bidders are intended to be sealed bids and are most often to be single instance sealed bids. The sealed bids are collected from the bidders and maintained as inaccessible from the traders and online administration staff until certain conditions have been met.

United States Patent Publication No. 2002/0147674, published on Oct. 10, 2002, discloses an electronic buying system and method that dynamically matches a person or business entity requesting a specialized product with a person or entity capable of providing that product. The system and method may function as a reverse auction where the buyer may reserve the right to refuse all bids. The system provides for feedback from buyers and sellers.

United States Patent Publication No. 2002/0184088, published on Dec. 5, 2002, discloses the use of a system and method for the presentation of advertisements where a number of impressions of an advertisement message are presented over a computer network such as the Internet, to a variety of viewer computers. Depending on the actions taken by the viewers, bonus exposure of the adverting message can also be given.

United States Patent Publication No. 2003/0028469, published on Feb. 6, 2003, teaches methods for buying and selling “information” goods, i.e., newspapers, books, electronic media, etc. The method involves requests to buyers and sellers and matching procedures.

United States Patent Publication No. 2003/0088506, published on May 8, 2003, describes a method and system to facilitate an electronic commerce transaction, which includes receiving an offer for an item from a user of an electronic commerce system. The item is available for purchase via an auction facilitated by the electronic commerce system and the item is automatically awarded to the user of the offer if it is at or above a posted selling price.

U.S. Pat. No. 5,283,731, issued to Lalonde et al. on Feb. 1, 1994, discloses a computerized classified ad system and method that has a data processor for creating an ad database with a plurality of ads each containing text data describing an item to be made available through the system.

U.S. Pat. No. 5,592,375, issued to Salmon et al. on Jan. 7, 1997, teaches a computerized system for brokering transactions between sellers and a buyer of goods and services that includes a database, a seller's interface and a buyer's interface. The database contains information including multimedia information, respective of goods and services. The seller's interface enables the sellers to interactively enter information, including multimedia information into the database. The buyer's interface provides a knowledge-based interactive protocol, enabling the buyer to select and review the descriptive information from the database.

U.S. Pat. No. 5,745,882, issued to Bixler et al. on Apr. 28, 1998, describes an interface for an electronic classified advertising system. The interface includes the capability for the user to enter search criteria for an item of interest, to save the search criteria and to be notified by the system when an item matching the search criteria is entered into the system.

U.S. Pat. No. 5,960,411, issued to Hartman et al. on Sep. 28, 1999, discloses a system and method for placing purchase orders via the Internet. The order is placed by a purchaser at a client system and is received by a server system. The server system receives purchaser information including identification of the purchaser, payment information and shipment information from the client system. The server system then assigns a client identifier to the client system and associates the assigned client identifier with the received purchaser information.

U.S. Pat. No. 6,253,188, issued to Witek et al. on Jun. 26, 2001, teaches a computerized, interactive classified ad system and method of operation for use on the Internet utilizing ads from regional newspaper Web servers. The system and method feature simple access, rapid response and automated updating, with elements and steps for maintaining the ad system database during operation in predominantly numeric form disposed in the RAM of a database server.

U.S. Pat. No. 6,647,373, issued to Carlton-Foss on Nov. 11, 2003, describes the use of a computer network enabling communication between a host computer and a plurality of remote bidders, or between a peer computer and a plurality of peer bidders that provide a system and method for transmitting and processing reverse auction information implemented as a computer program within the network and computers on which the program operates.

International Patent No. WO 01/02981, published Jan. 11, 2001, discloses a system for operating a reverse auction on a communications network that includes an anonymous e-mail system for information requests from the buyer to the seller.

None of the above inventions and patents, taken either singly or in combination, is seen to describe the instant invention as claimed. Thus a system and method for a buyer driven transaction solving the aforementioned problems is desired.

### SUMMARY OF THE INVENTION

The system and method for a buyer driven transaction includes a Web site where buyers can post ads for goods or services that the buyer wishes to purchase and specify a price the buyer is willing to pay for the goods or services. Sellers can browse the posted buyer ads and tender offers, and the system also includes a database in which sellers can post an inventory of goods or services and a price at which the sellers are willing to sell. When a buyer posts an ad, a search engine searches the database to match a seller with the buyer, and matches are displayed to the buyer so that the buyer can make an offer to the seller. Alternatively, a buyer can browse the seller database and make an offer for merchandise listed in the database.

The system includes an e-mail system for providing communications between buyers and sellers. The system also provides for feedback, in which buyers and sellers can rate their satisfaction with each other, so that buyers and sellers can look up the past history ratings of the other party. The system also includes a feature in which a seller can specify a desire to sell merchandise in a specified amount, and the system will search pending buyer ads to match the specified amount, whereupon the seller can determine if he or she has the requested merchandise for sale and, if so, make an offer to the buyer.

Accordingly, it is a principal object of the invention to provide a computerized system and method for a buyer driven transaction that is driven by a buyer request for goods or services at a specified price that matches buyers with sellers without an auction.

It is another object of the invention to provide a computerized system and method for a buyer driven transaction that allows buyers to passively post ads and wait for sellers to respond with matching offers, or to browse a database of seller inventories for the desired product or service.

It is a further object of the invention to provide a computerized system and method for a buyer driven transaction that allows sellers to either browse posted buyer ads specifying desired products or services and price requirements, or to post an inventory of products or services for sale.

Still another object of the invention is to provide a computerized system and method for a buyer driven transaction that automatically searches a seller database for a match when a buyer posts an ad for a product or service at a specified price.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is a block diagram of a computerized system on which a buyer driven transaction according to the present invention operates.

FIG. 1B is a diagram of a reverse selling network according to the present invention.

FIG. 1C is a flowchart of the steps of an overall method for a buyer driven transaction according to the present invention.

FIG. 2A and FIG. 2B combined is a screenshot of a representative home page of a Web site of a computerized system for a buyer driven transaction according to the present invention.

FIG. 3A, FIG. 3B, FIG. 3C and FIG. 3D are screenshots of a representative “About” Web page of the Web site of FIGS. 2A-2B.

FIG. 4A and FIG. 4B are screenshots of a representative registration information Web page needed to register a user on the Web site of FIGS. 2A-2B.

FIG. 5A and FIG. 5B are screenshots of a representative “Help” Web page on the Web site of FIGS. 2A-2B.

FIG. 6A and FIG. 6B are screenshots of a representative “Detailed Search” Web page on the Web site of FIGS. 2A-2B.

FIG. 7A and FIG. 7B are screenshots of a representative “Treasure Hunter” Web page on the Web site of FIGS. 2A-2B.

FIG. 8A and FIG. 8B are screenshots of a representative “iASKiBUY Store” Web page on the Web site of FIGS. 2A-2B.

FIG. 9A and FIG. 9B are screenshots of a representative “Feedback Form” Web page on the Web site of FIGS. 2A-2B.

FIG. 10A and FIG. 10B are screenshots of a representative “Innovate Your Business With iASKiBUY.com” Web page on the Web site of FIGS. 2A-2B.

FIG. 11A and FIG. 11B are screenshots of a representative “Sign-In” Web page on the Web site of FIGS. 2A-2B.

FIG. 12 is a flowchart showing the steps in a buyer's usage of a system and method for a buyer driven transaction according to the present invention.

FIG. 13 is a flowchart showing the steps in a seller's usage of a system and method for a buyer driven transaction according to the present invention.

Similar reference characters denote corresponding features consistently throughout the attached drawings.

### DETAILED DESCRIPTION OF THE PREFERRED EMBODIMENT

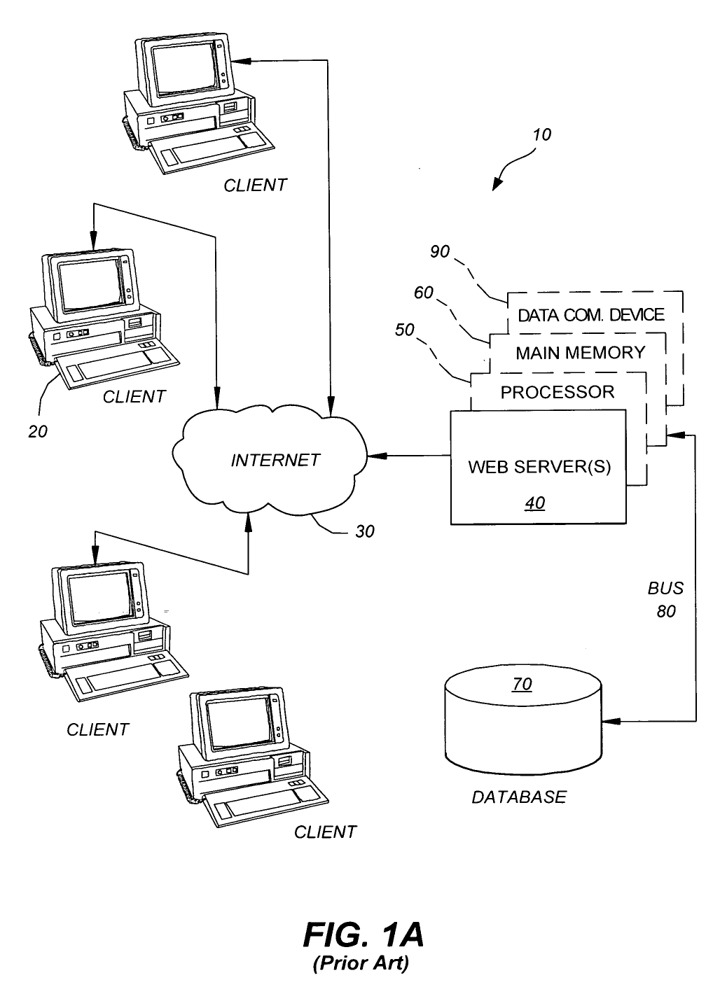

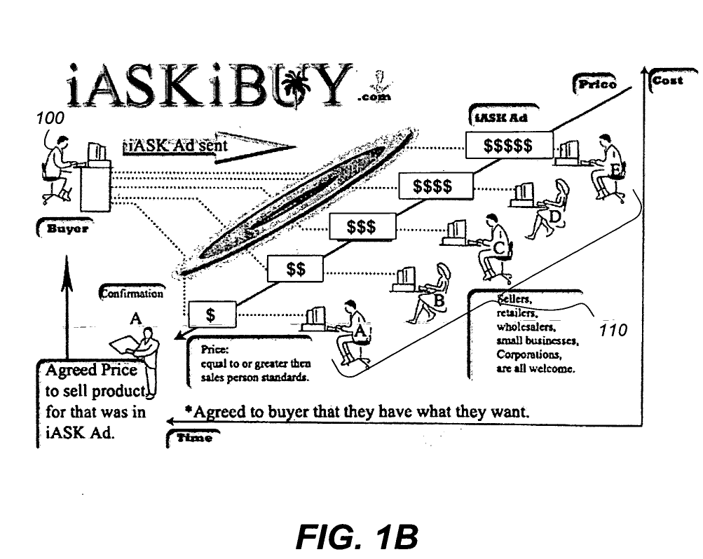

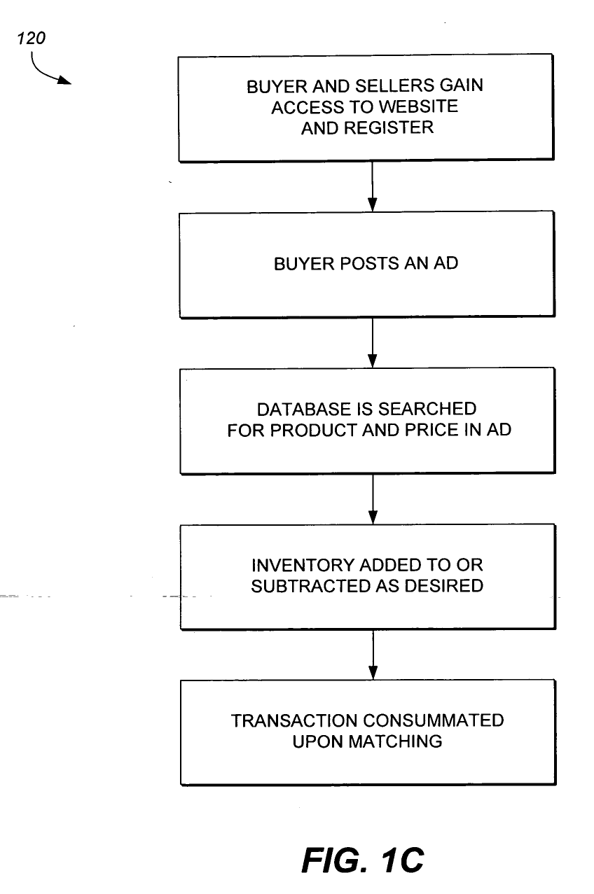

The present invention is a system and method for a buyer driven transaction. A computerized system 10 on which the present invention operates is shown in FIG. 1A. The computerized system 10 uses a client-server model, including a plurality of clients 20 connected to a Web server 40 through a computer network, preferably the Internet 30, although the computerized system 10 may operate on an intranet or extranet. The Web server 40 has a processor 50 for processing instructions and an area of main memory 60 for executing program code under the direction of the processor 50 connected by a bus 80.

The computerized system 10 also includes at least one relational database 70 for storing data. The relational database(s) 70 may reside in an area of disk storage on the Web server 40 and be connected to the main memory by the bus 80, or may reside on a remote database server accessible by the Web server 40, as is known in the art. A data communications device 90 is connected to the bus 80 for connecting the Web server 40 to the Internet 30. The client computers 20 have a Web browser operable thereon for receiving and viewing documents written in Hypertext Markup Language (HTML) and are transmitted over the Internet 30 via Hypertext Transfer Protocol (HTTP) by the Web server 40 and transmit requests for HTML documents to the Web server 40 via HTTP.

The present invention includes software program code stored on a computer readable medium and is operable in main memory on the Web server 40 for performing a numerically buyer driven transaction, which are accessible to a client computer 20 through the Internet 30. As used in the present application, the term “computer readable medium” refers to a hard disk drive, a floppy diskette, a ZIP disk or any other magnetic storage media capable of storing coded program instructions, an optical or laser storage device, such as a compact disk, laser disk, paper tape, punch cards or any other media for the storage of program instructions readable by a disk storage device or reader. The computer code may be written in Java (Java is a trademark of Sun Microsystems), HTML, XML, PERL or Microsoft's Active Server Pages (ASP), and includes code for performing a numerically buyer driven transaction.

A Web-based overall method for customizing a design for performing a buyer driven transaction has computer program code that is stored in the storage device and executes in the main memory 60 under the direction of the processor 50. The computer program includes a Web server software means for a buyer driven transaction on at least one Web site on the Internet 30.

FIG. 1B depicts the reverse transaction that takes place with the computerized system 10. A reverse transaction is defined in this application to be a transaction where a buyer 100 will indicate that he or she desires a particular product or service to a plurality of sellers 110 that will respond to the desired product or service. This is opposed to a typical traditional buyer and seller relationship where a seller 110 offers what he or she has available to a buyer 100 with the seller 110 initiating the transaction.

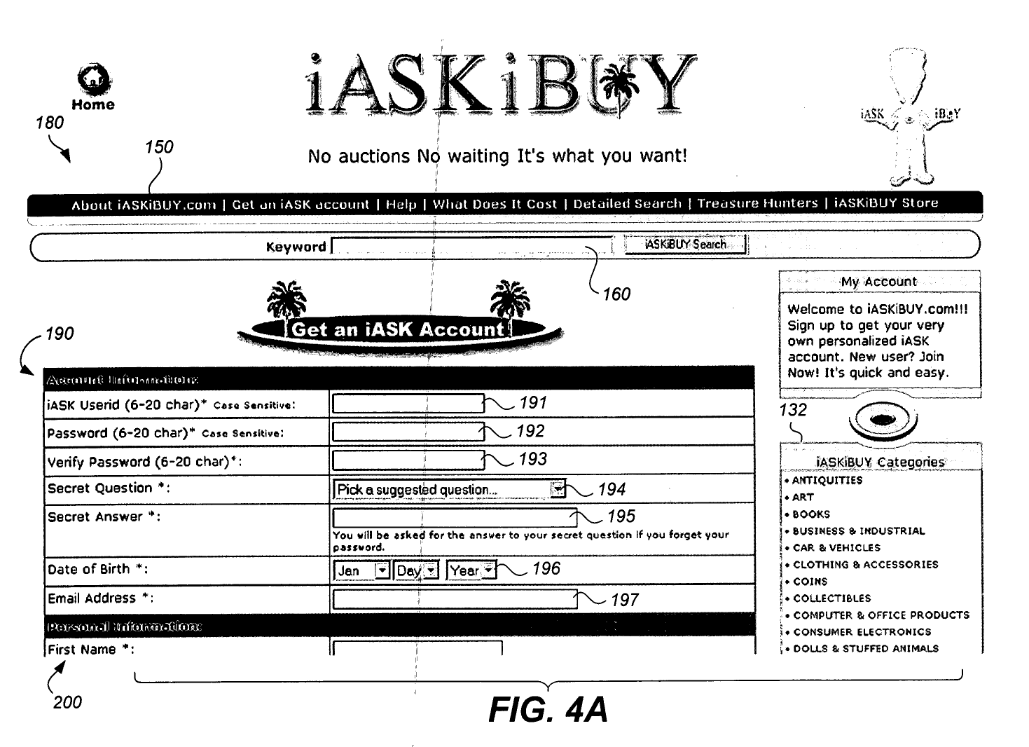

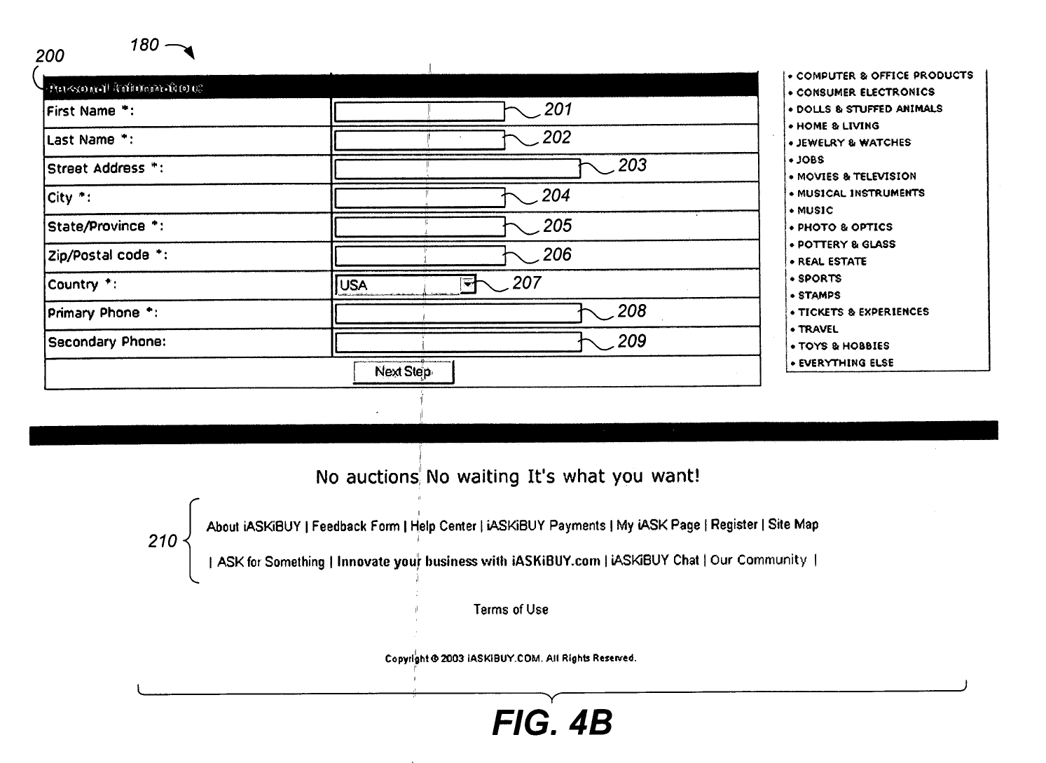

FIG. 1C outlines an overall method 120 that is used with the computerized system 10. First, both buyers 100 and sellers 110 must gain access to the computerized system 10. This can be easily done by accessing a Web site through the use an Internet connection. Once access is obtained, both buyers 100 and sellers 110 can register on the computerized system 10 depicted in FIG. 4A and FIG. 4B. Once registered, a buyer 100 can post an ad within the computerized system 10 for any sellers 110 to respond to. After the ad is posted, the relational database 70 is searched for a product and price match. Note that inventory can be added or subtracted as desired by the sellers using the computerized system 10. Inventory can remain in the relational database 70 until a match is found and a transaction is consummated.

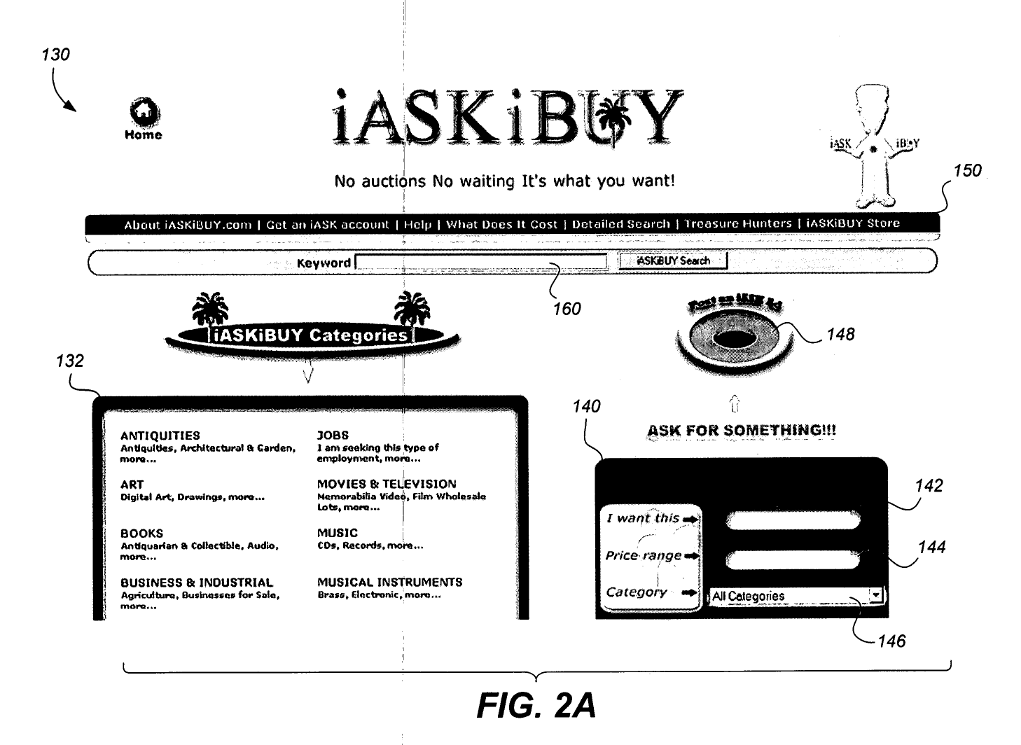

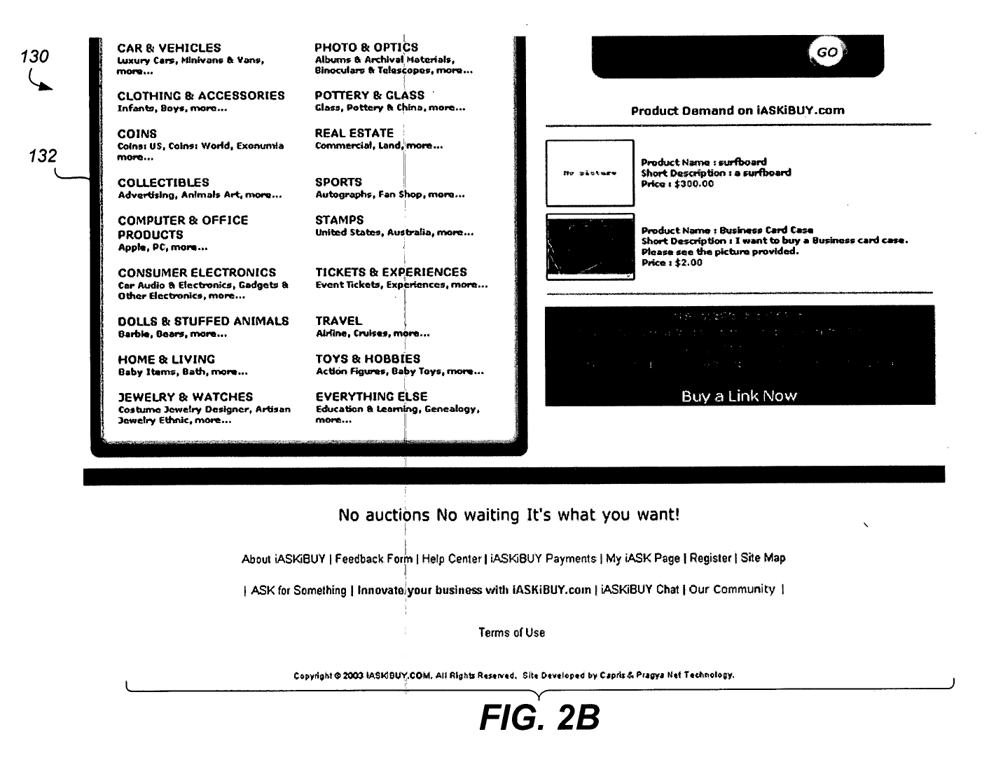

FIG. 2A and FIG. 2B are representative screenshots of a home page 130 of a Web site (titled “iASKiBUY” in the specification and drawings) for carrying out the invention. This includes a listing of the different categories 132 that the inventory is organized into. An ad listing table 140 is also included on the home page 130 that requires what is wanted by the buyer 142, a price range 144 for the product or service described in the ad, and a category 146 that the product or service can be classified under. The ad can be posted in the computerized system 10 by clicking on the “Post an iASK ad” button 148. Various other screenshots can be accessed on a selection bar 150 and a keyword search engine 160 is also provided to search the relational database 70.

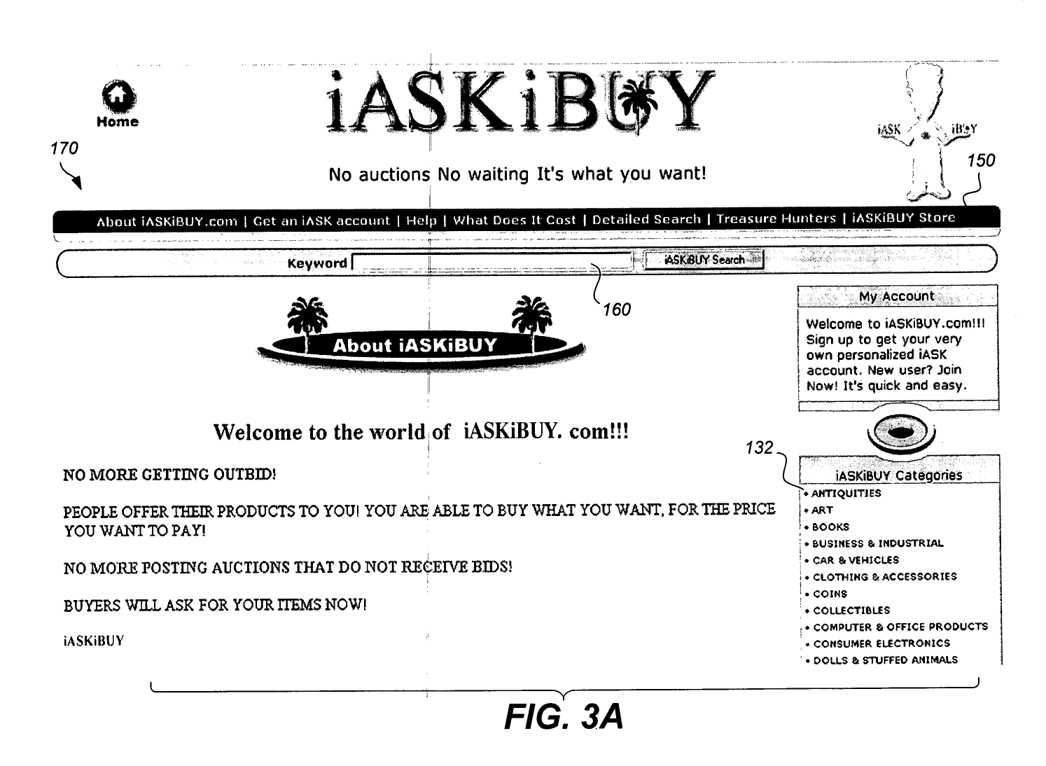

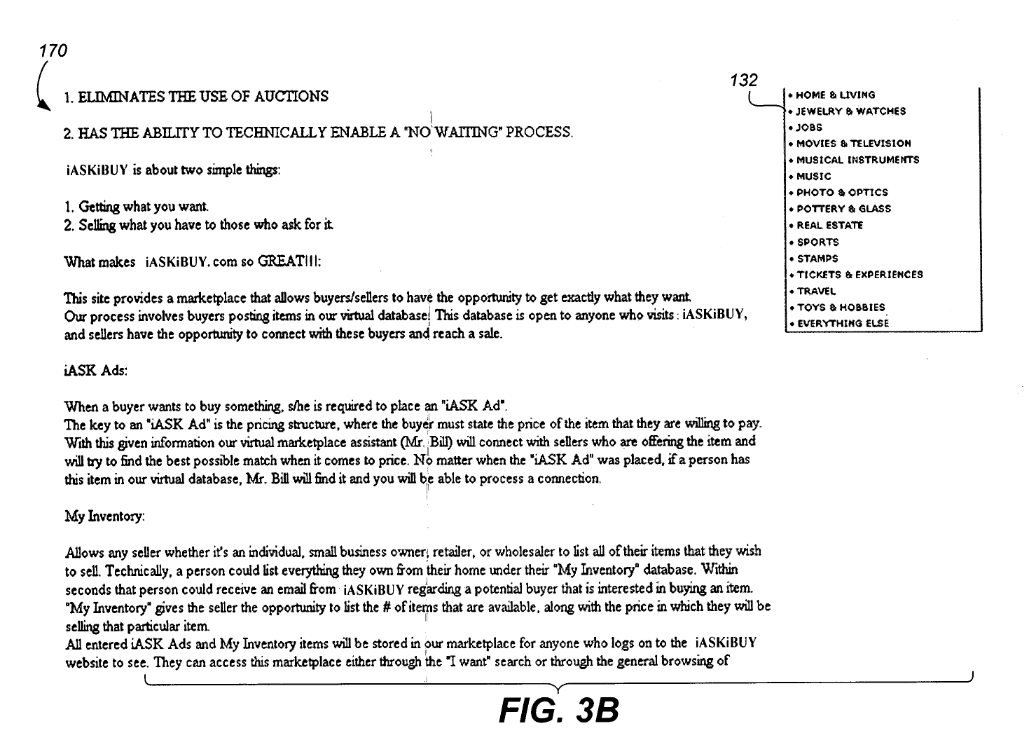

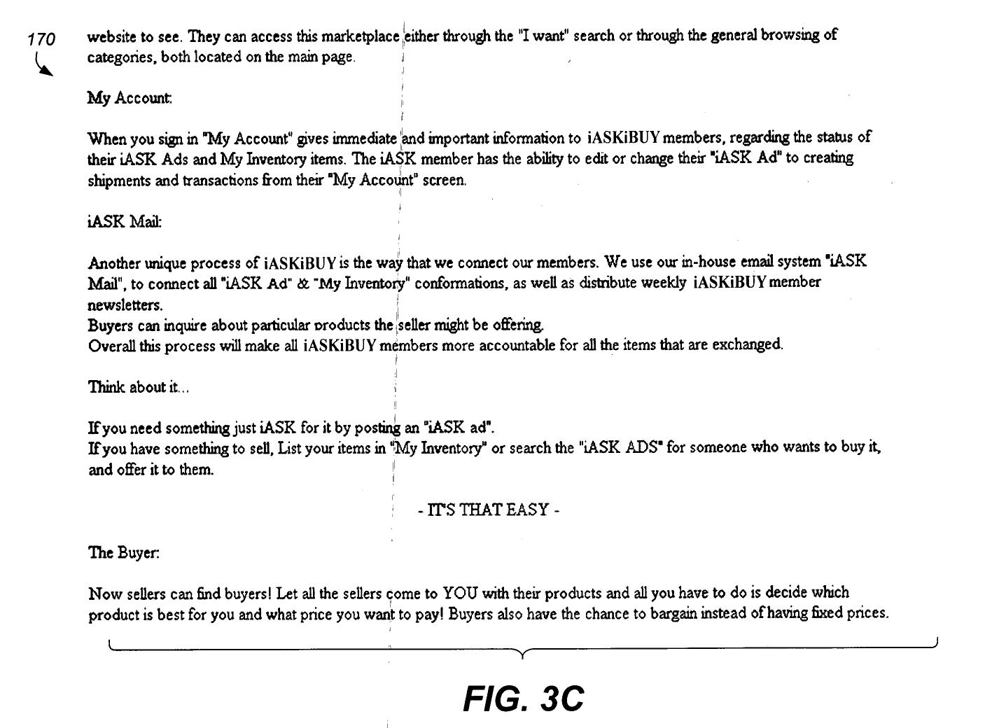

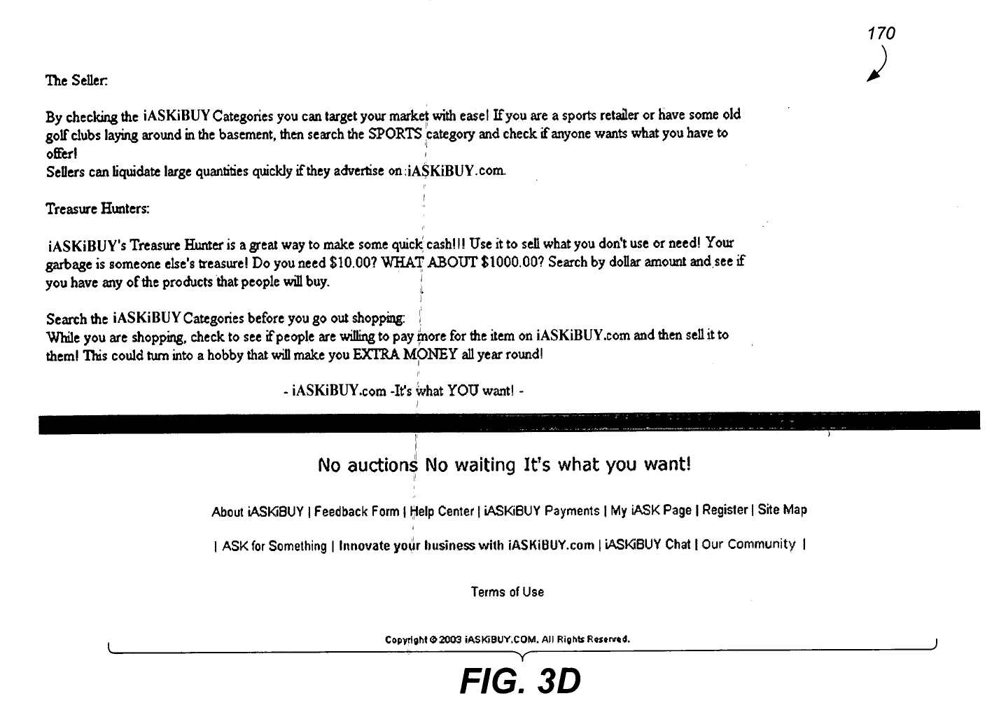

FIG. 3A, FIG. 3B, FIG. 3C and FIG. 3D depict information about the computerized system 10 in the representative “About” Web page screenshots 170. A listing of the categories 132, a search engine 160 and a selection bar 150 are all provided on the “About iASKiBUY.com” screenshots 170. Specific information about inventory, ad information, internal e-mail and information about the Treasure Hunter capability is also provided.

FIG. 4A and FIG. 4B depict representative registration information for the Web site in the “Get an iASK account” screenshots 180. This includes the selection bar 150, the search engine 160 and the listing of categories 132. Account information 190 such as a user ID 191, a password 192, a password verification 193, a secret question 194, a secret answer 195, the user's date of birth 196 and e-mail address 197 is provided and required to be entered. Personal information 200 such as a user's first name 201, last name 202, street address 203, city 204, state or province 205, zip or postal code 206, country 207, primary phone 208 and secondary phone 209 are also provided. Additional selection lines 210 are also provided beneath the personal information 200.

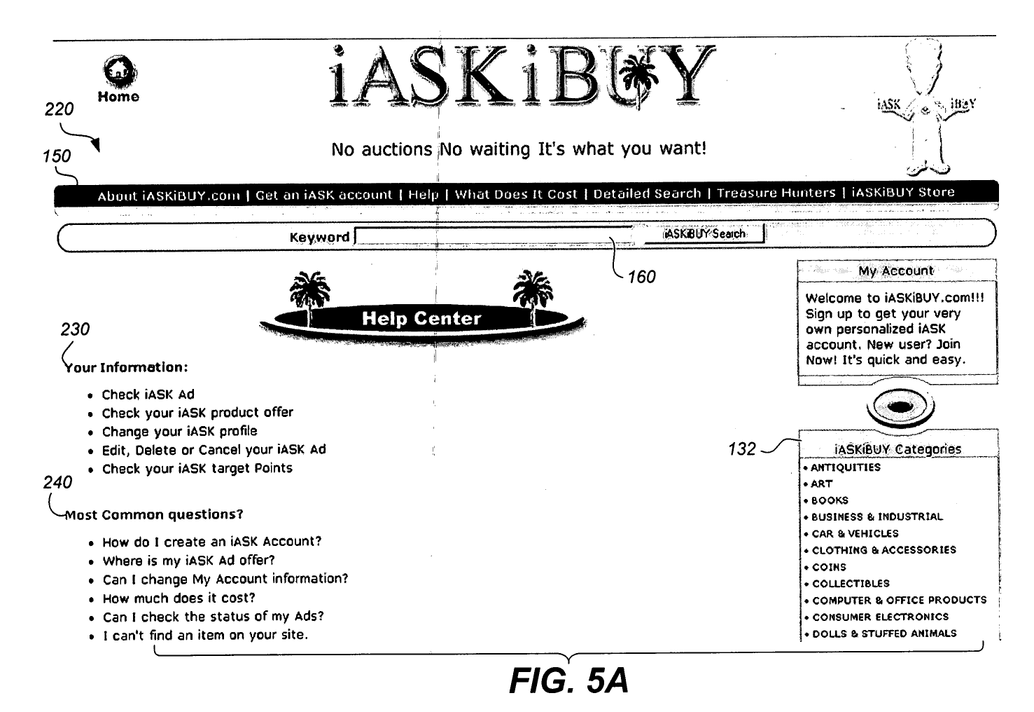

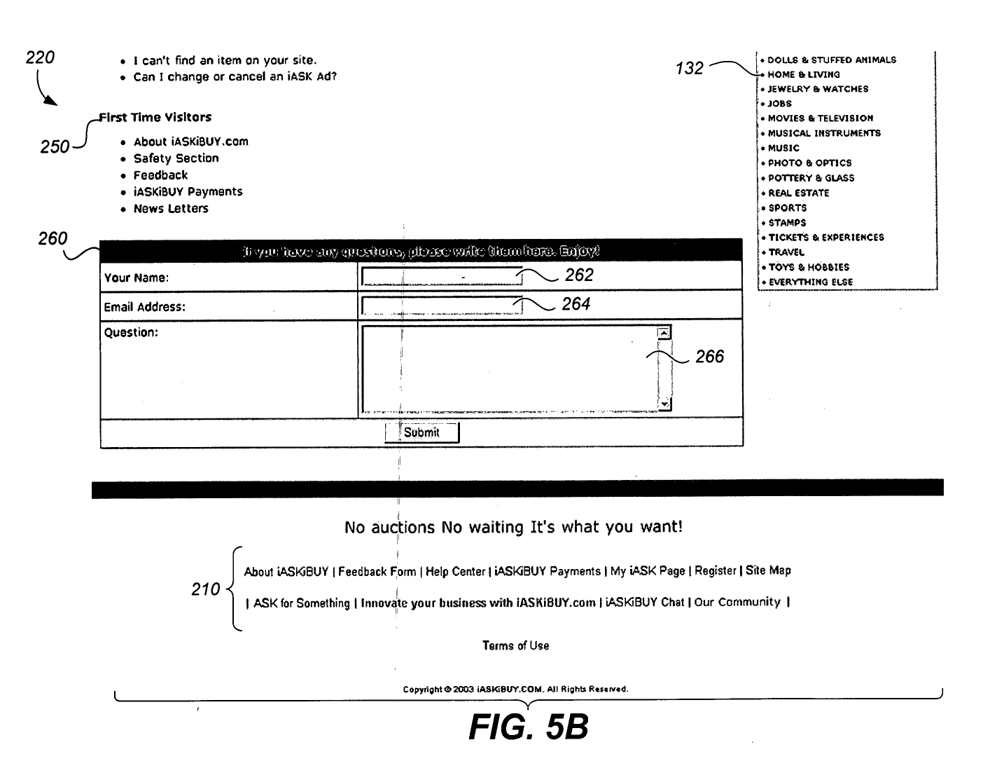

FIG. 5A and FIG. 5B depict a representative “Help” screenshot 220 for the computerized system 10. The “Help” screenshot 220 includes the selection bar 150, the search engine 160 and the listing of categories 132. The “Help” screenshot 220 also supplies links where a user's information 230 can be checked, where the most common questions 240 are asked, where first time visitor guidelines 250 can be checked and a locale where question information 260 can be directed to the computerized system 10. The question information 260 includes a user's name 262, a user's Email address 264 and a space for a user to enter a detailed question 266. There are also additional selection lines 210 directly under the question information 260.

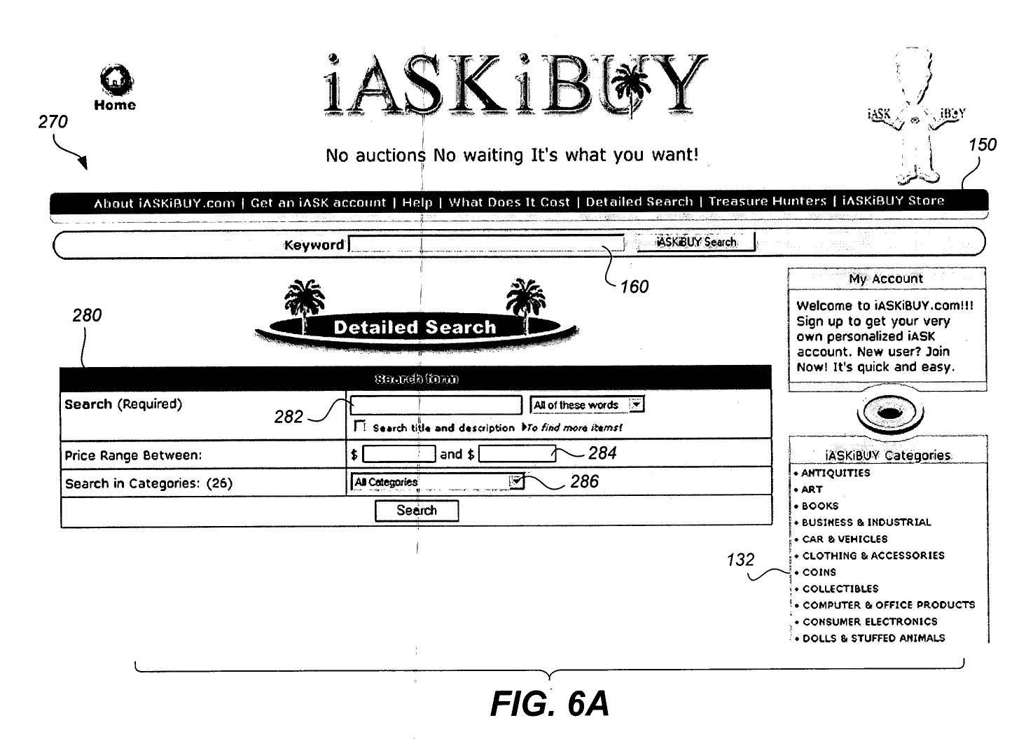

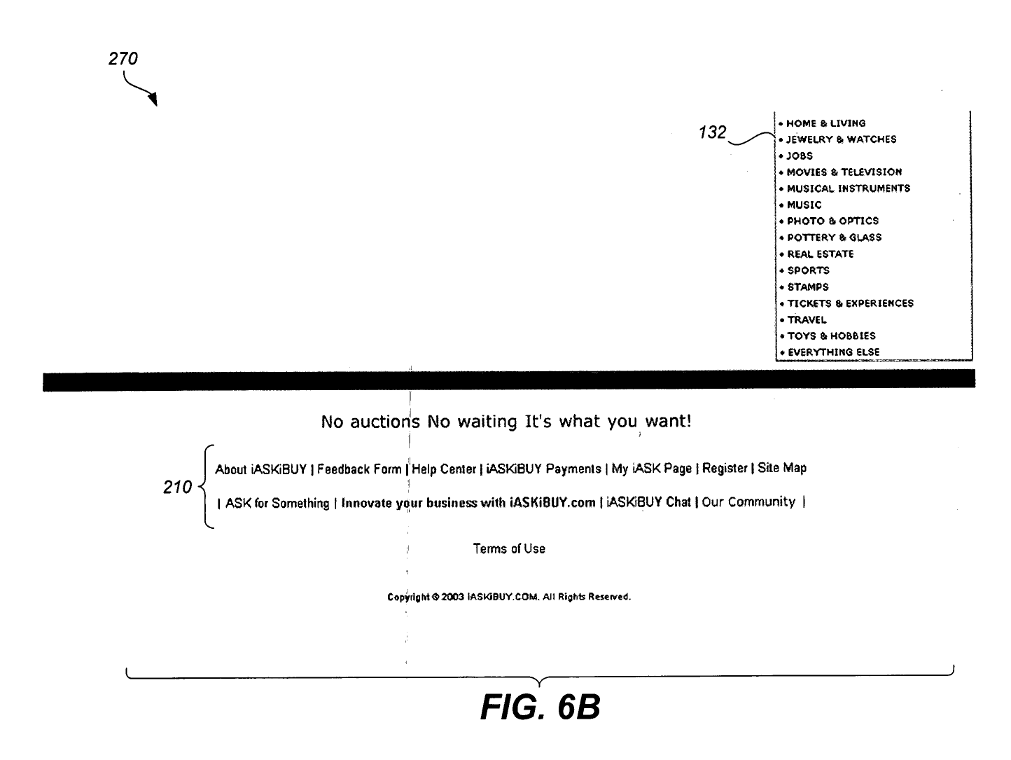

FIG. 6A and FIG. 6B depict a representative “Search data” Web page screenshot 270 of the computerized system 10. The “Search data” screenshot 270 includes the selection bar 150, the earlier search engine 160 and the listing of categories 132. The “Search data” screenshot 270 is used to perform a more detailed and precise search than the first search engine 160. An additional search form 280 is also provided that includes key words 282, price ranges 284 and categories 286. There are also additional selection lines 210 below the additional search form 280.

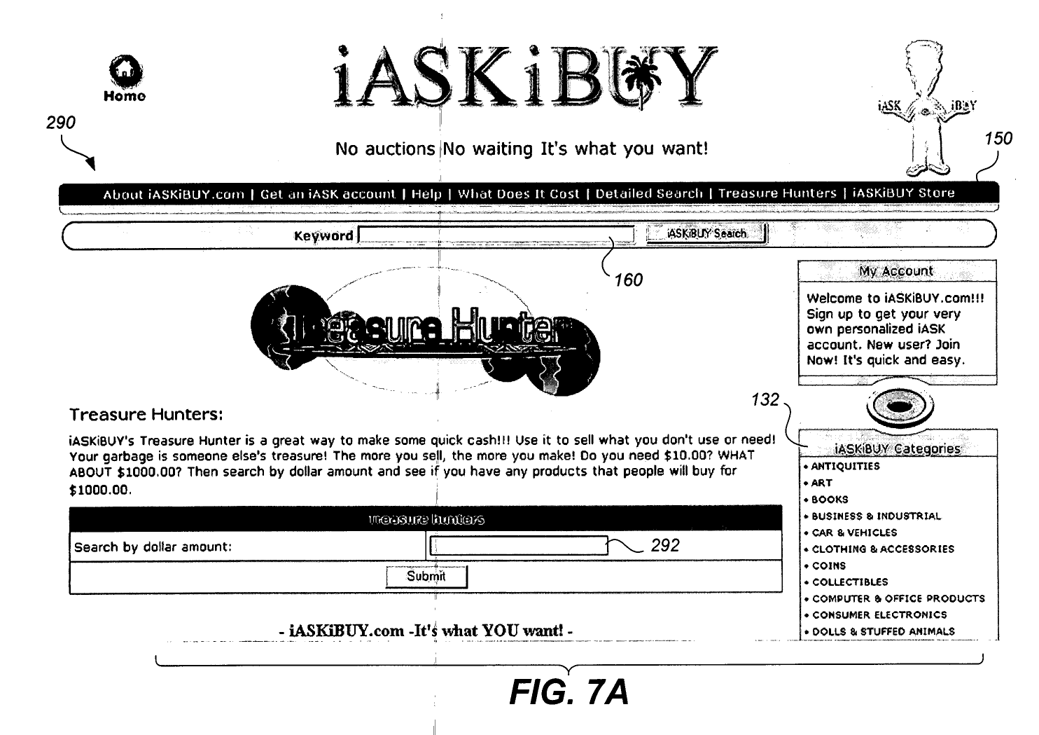

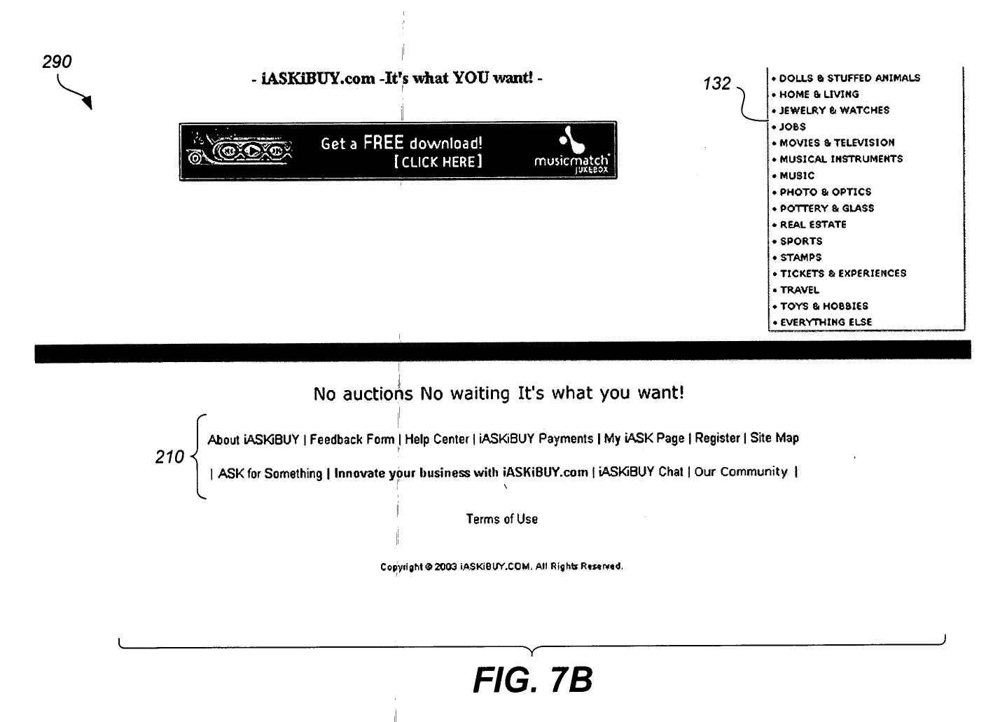

FIG. 7A and FIG. 7B depict a representative “Treasure Hunter” Web page screenshot 290 of the computerized system 10. The “Treasure Hunter” screenshot 290 includes the search engine 160, the selection bar 150 and the listing of categories 132. The “Treasure Hunter” screenshot 290 allows a seller 110 to quickly sell items that total a desired amount. The “Treasure Hunter” screenshot 290 includes a dollar amount 292 that is entered by the user. There are also additional selection lines 210 on the lower portion of the “Treasure Hunter” screenshot 290. When the form is submitted, a search of a database of posted buyers' ads is performed to match the dollar amount specified, and potential matches are displayed. If the seller has any of the items requested by one or more buyers, and is willing to sell at or near the price named by the buyer(s), the seller may tender an offer to the buyer through the in-house e-mail system.

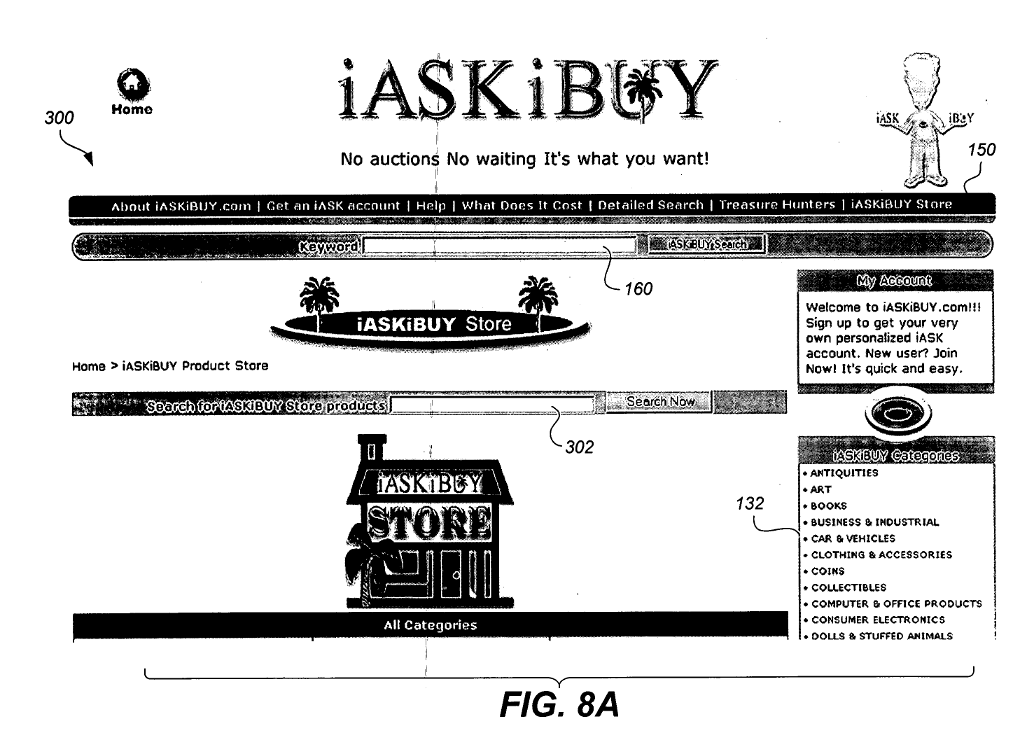

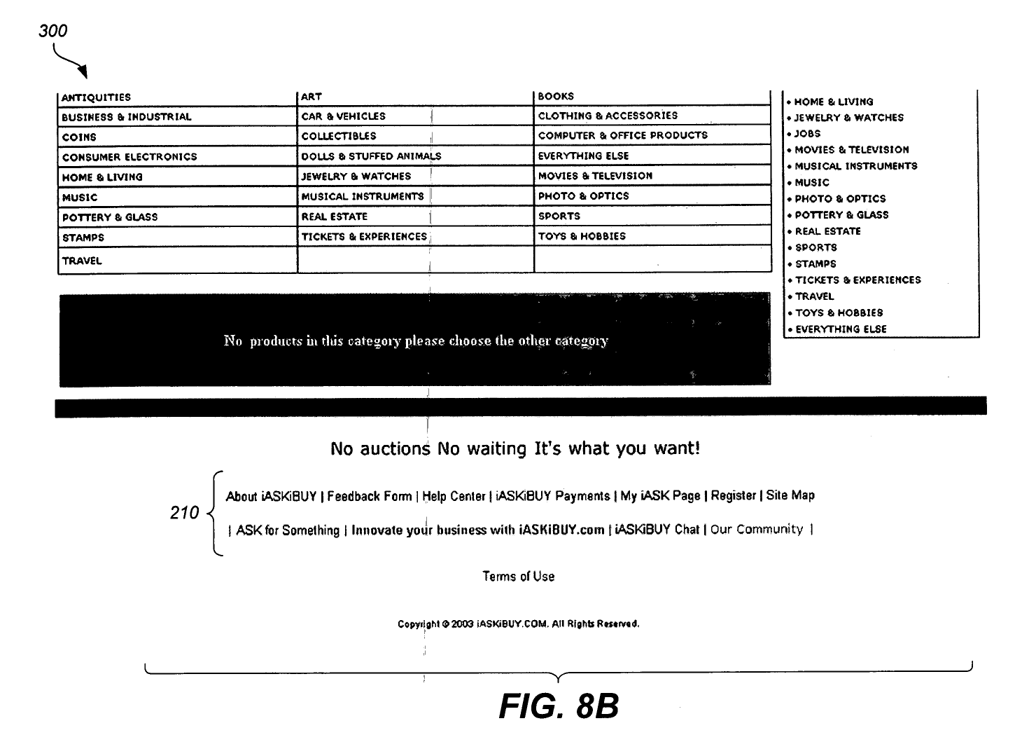

FIG. 8A and FIG. 8B depict a representative “iASKiBUY Store” Web page screenshot 300 of the computerized system 10. The “iASKiBUY Store” screenshot 300 includes the selection bar 150, the search engine 160, the listing of categories 132 and the additional selection lines 210. A buyer may browse products and services in the seller database by category to see if the desired merchandise is available without posting an ad. There is also an additional search engine 302 specifically for the “iASKiBUY Store” screenshot 302 and that is more precise than the first search engine 160.

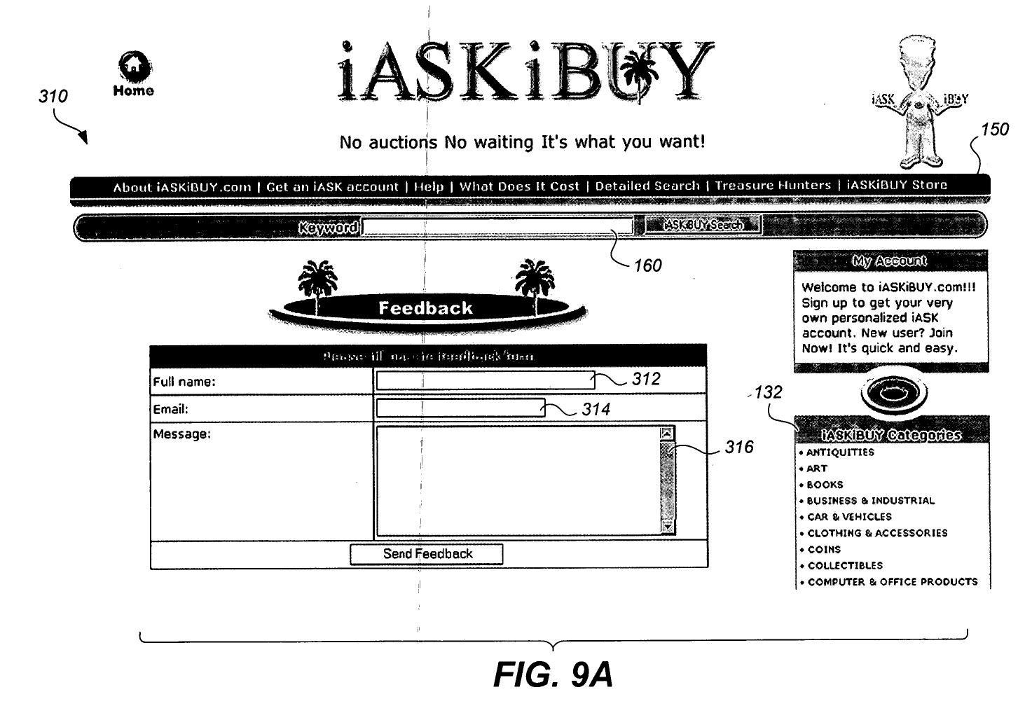

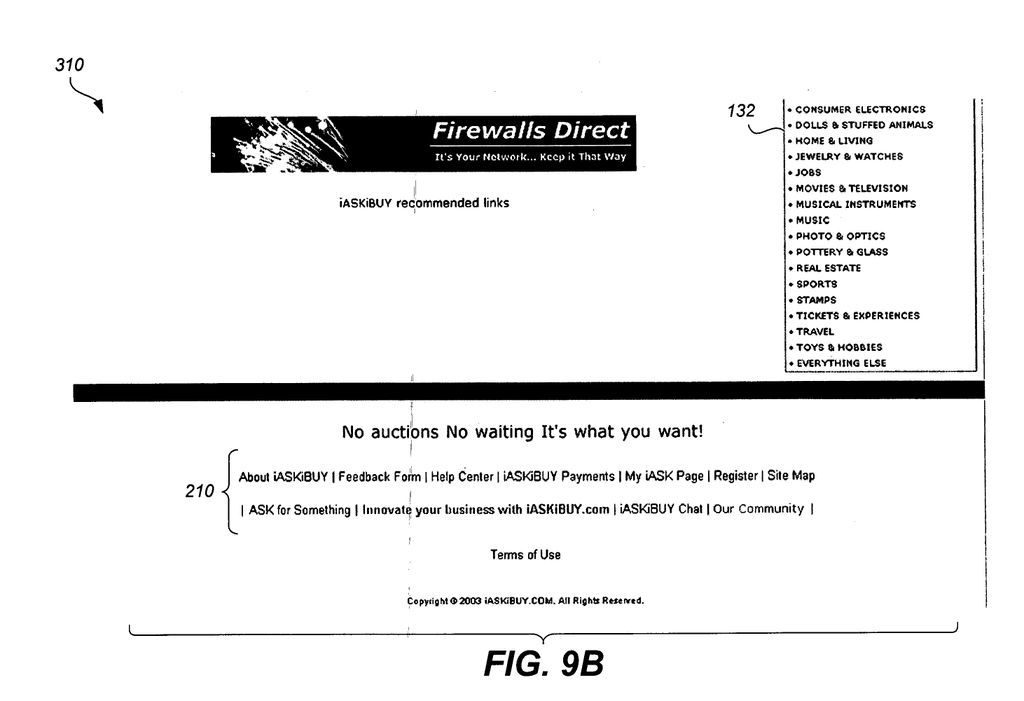

FIG. 9A and FIG. 9B depict the “Suggestions and Feedback” screenshot 310 of the computerized system 10. The “Suggestions and Feedback” screenshot 310 includes the selection bar 150, the search engine 160, the listing of categories 132 and the additional selection lines 210. Specifically, this also includes the user's full name 312, Email address 314 and feedback message 316. Messages are analyzed by the system to determine buyer and seller satisfaction or dissatisfaction with the other party, and information regarding the feedback may be rated numerically and posted on the Web site so that buyers and sellers can check past history of the other party.

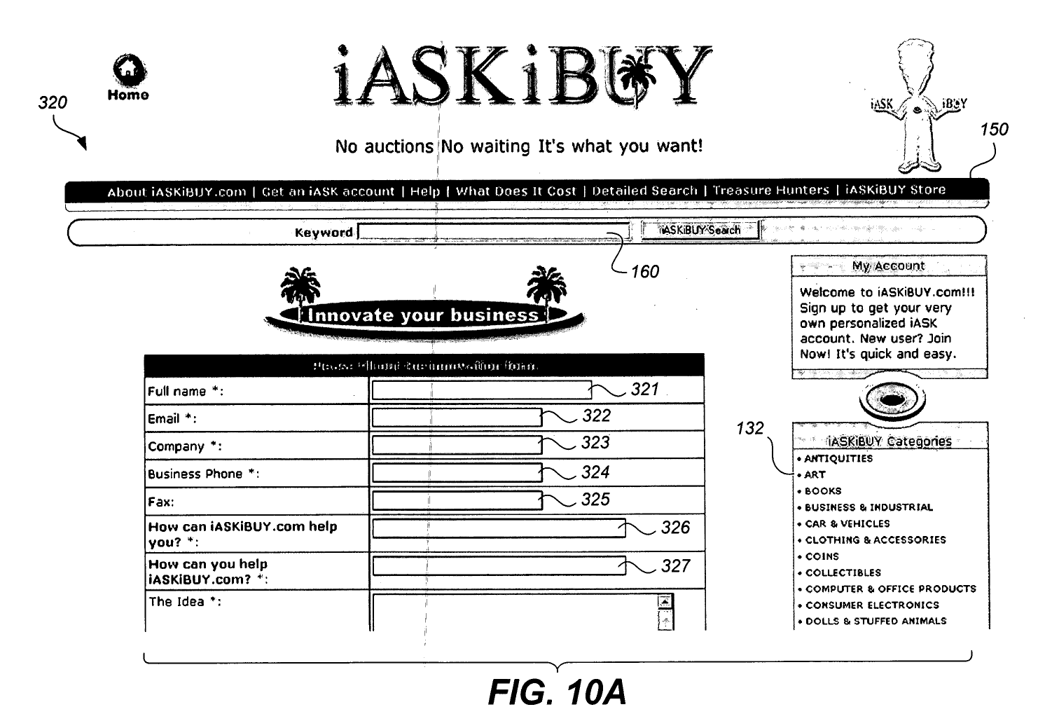

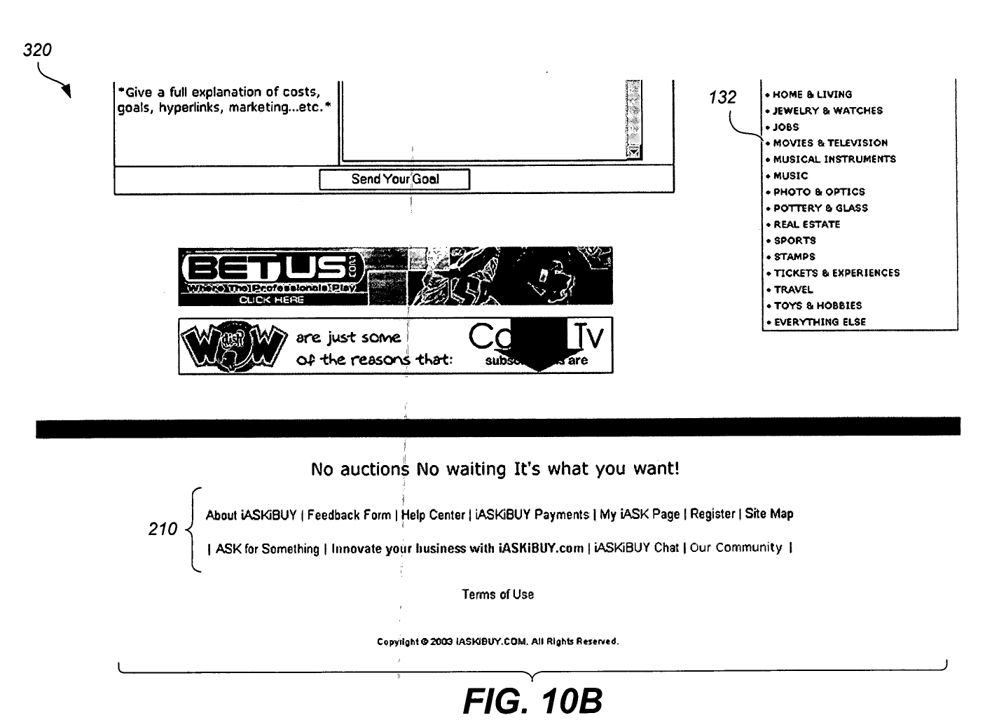

FIG. 10A and FIG. 10B depict a representative “Innovate Your Business” Web page screenshot 320 of the computerized system 10. The “Innovate Your Business” screenshot 320 has the selection bar 150, the first search engine 160, the listing of categories 132 and the selection lines 210. The core information of the “Innovate Your Business” screenshot 320 includes a user's full name 321, Email address 322, company 323, business phone 324, fax 325, an answer to the question, “How can iASKiBUY.com help you?”, 326 an answer to the question, “How can you help iASKiBUY.com?” 327 and an explanation of any new idea 328. The “Innovate Your Business” screenshots 320 are used to exchange novel ideas and information between users and the computerized system 10.

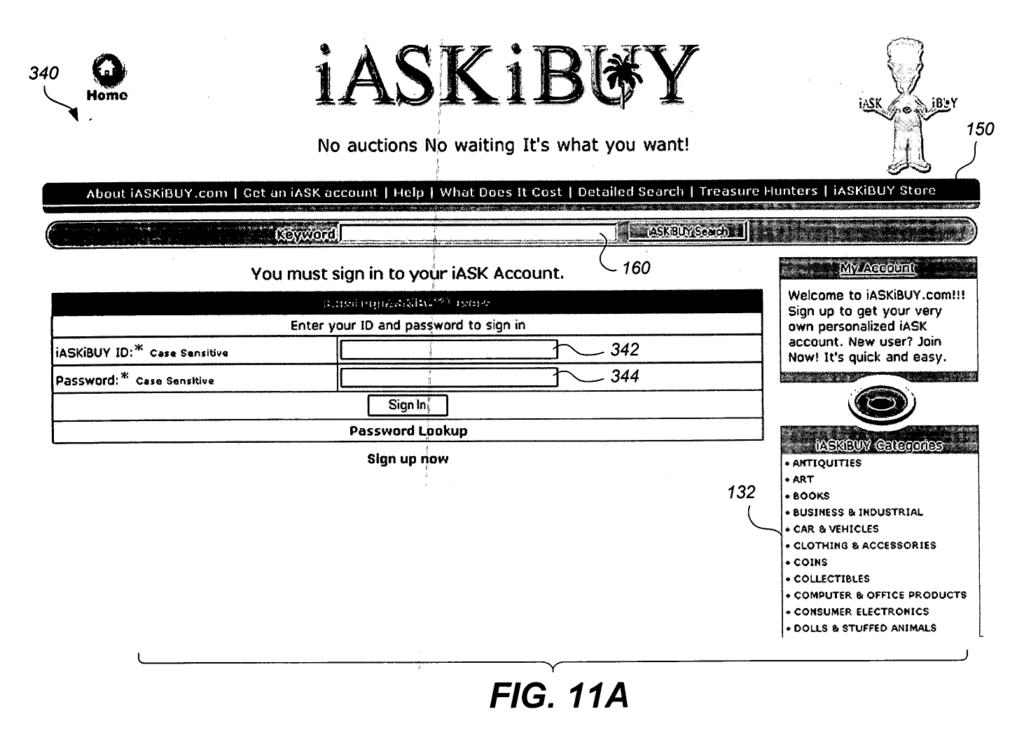

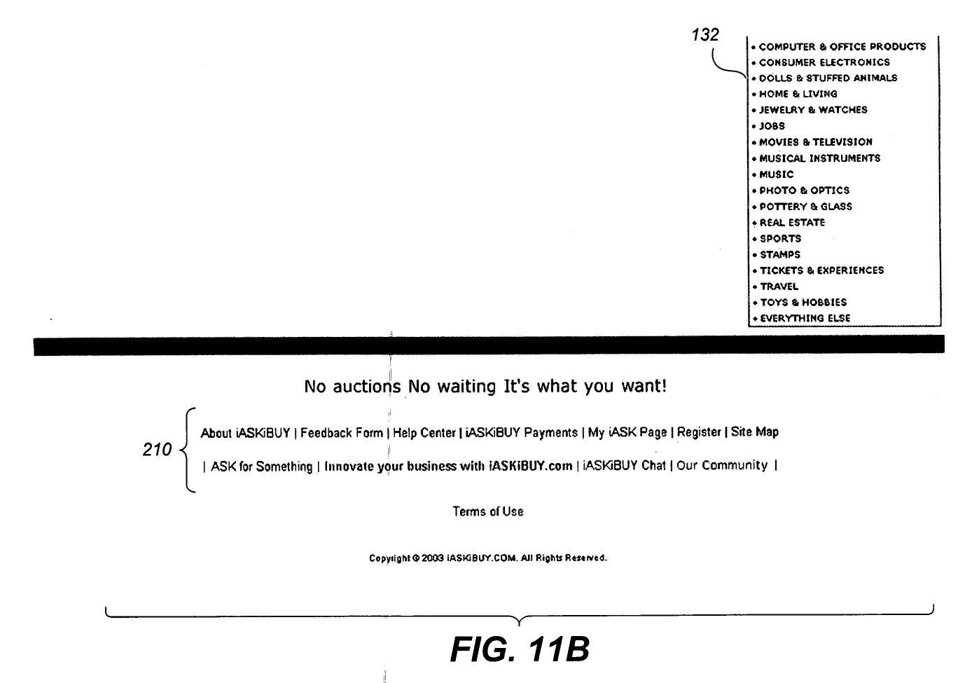

FIG. 11A and FIG. 11B depict a representative “Sign-In” Web page screenshot 340 of the computerized system 10. The “Sign-In” screenshot 340 has the selection bar 150, the search engine 160, the listing of categories 132 and additional selection lines 210. The “Sign-In” screenshot 340 also has a case sensitive ID 342 and password 344 that is previously established by the user.

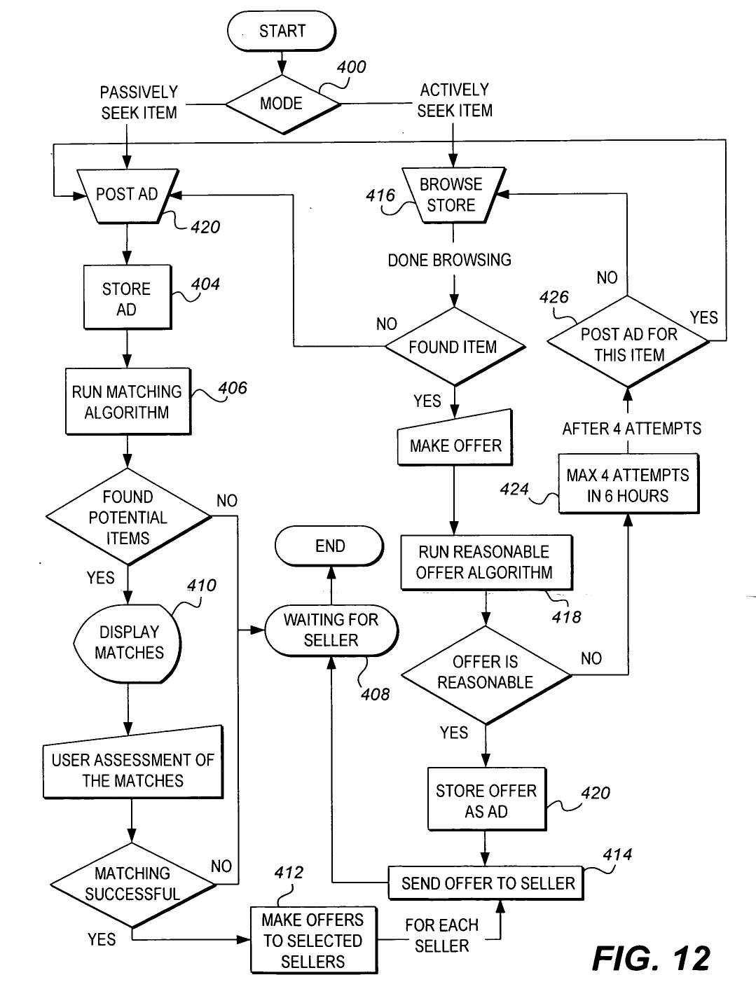

FIG. 12 is a flowchart depicting the steps for buyer usage of the system and method for a buyer driven transaction of the present invention. The buyer selects the mode of using the system at step 400. If the buyer elects to passively seek a seller, the buyer posts an ad at step 402, which includes either a general or detailed description of the product or service desired (which may include a photograph) and a price, or price range, that the buyer is willing to pay. The ad is stored in a buyer's database, or a buyer's table in a unified system database, at step 404, and a matching algorithm is run by the computerized system at step 406 to determine if the buyer's ad can be matched to products or services stored in a seller's database, or a seller's table in a unified system database.

The matching algorithm generally includes a series of steps for comparing terms listed in the buyer's product or service description with terms listed in the seller's product or service description, comparing the buyer's desired price (or price range) with the sellers' price (or price range), and determining potential matches. The algorithm may use fuzzy logic or other artificial intelligence techniques to improve the likelihood of a match.

If no match is found, then the ad is simply posted and the buyer waits for contact from a seller at step 408. If any matches are found, the matches are displayed to the buyer at step 410. The buyer assesses the matches, and if any are suitable, the buyer makes an offer to the selected seller at step 412 by using an in-house e-mail system provided by the Web site that may either forward the e-mail directly to the seller at step 414, store an e-mail until the seller logs in to the Web site again, or both. The seller may then evaluate the buyer's offer and e-mail a response through the system's in-house e-mail accordingly.

Instead of posting an ad and passively waiting for a response from a seller, the buyer may actively seek a seller by browsing the system store at step 416 to see if a desired product or service is already available from a seller having merchandise data stored in the system's seller's database. The system store permits browsing the database by category, or by entry of specific search terms. If the item is found, the buyer may submit an offer and the system automatically runs a reasonable offer algorithm at step 418.

The reasonable offer algorithm determines whether the offer submitted by the buyer is in reasonable compliance with the seller's price (or price range) and any other terms or conditions described by the seller when posting the merchandise to the database. The algorithm may employ fuzzy logic or other artificial intelligence techniques to determine the reasonableness of the offer.

If the offer is deemed reasonable, the offer is stored at step 420, an e-mail is automatically generated, and the offer is conveyed to the seller by the in-house e-mail system at step 414. The seller may evaluate the offer and respond to the buyer through the system's in-house e-mail system.

If the system determines that the buyer's offer is not reasonable, the buyer is so informed and the buyer may make up to a maximum of four attempts to revise the offer within a six hour period at step 424. If the buyer is unable to do so, the buyer is presented with the option of posting an ad for the product or service at step 426 in accordance with the procedures previously described, or returning to browse further through the store database.

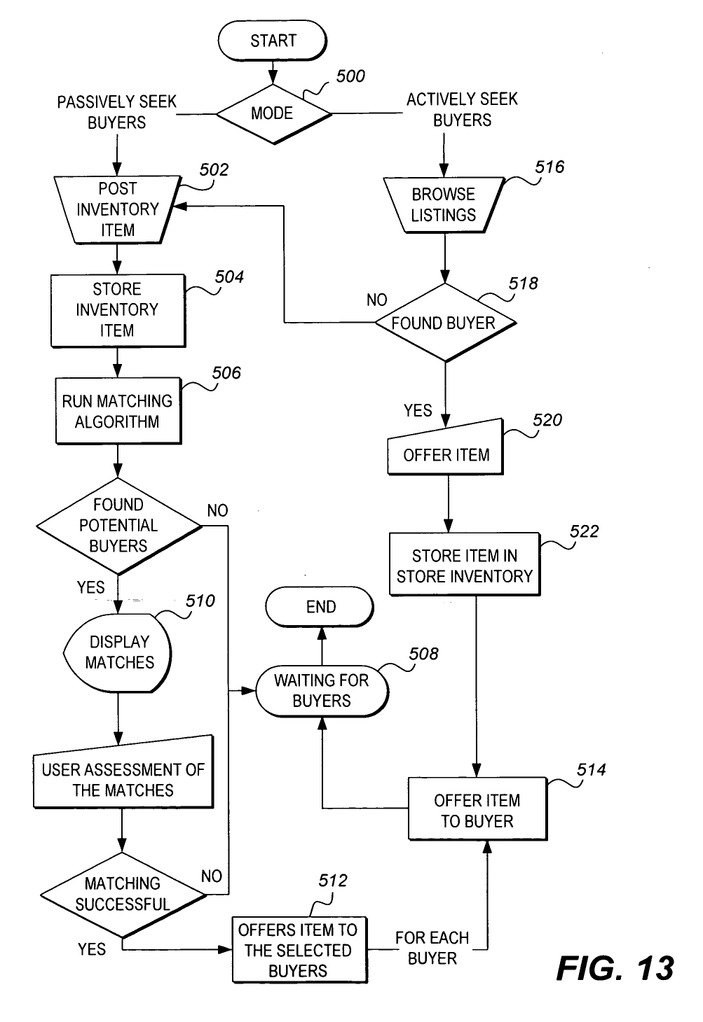

FIG. 13 shows a flowchart depicting the steps for seller usage of the system and method for a buyer driven transaction of the present invention. The seller selects the mode of using the system at step 500. If the seller elects to passively seek a buyer, the seller may post an inventory item for storage in the system's seller's database at step 502. The inventory item includes either a general or a detailed description of the product or service (which may include a photograph), together with any terms and conditions of sale, and a selling price (or price range) that the seller is willing to accept for the product or service. A seller may, for example, elect to list the entire contents of a home for sale, if desired, with a price listed for each individual item and/or a bulk price for the lot.

The inventory item is stored at step 504, and the system automatically runs a matching algorithm at step 506 to determine if there is a match to any ads posted by buyers at step 402 and stored in the buyer's database at step 404. The matching algorithm of step 506 is essentially the same as the matching algorithm of step 406, described above.

If no potential buyer is found, at step 508 the seller simply waits for a response from new buyer ads or buyers browsing the system store. If a potential match (or matches) is found, the match is displayed to the seller at step 510. The seller assesses the proposed match, and if the match is not acceptable, the seller waits for a new buyer at step 508. If a match may be acceptable, the seller makes an offer to the selected buyer at step 512 by using an in-house e-mail system provided by the Web site that may either forward the e-mail directly to the buyer at step 514, store an e-mail until the buyer logs in to the Web site again, or both. The buyer may then evaluate the seller's offer and e-mail a response through the system's in-house e-mail accordingly.

Instead of simply posting inventory and waiting for a buyer response, the seller may actively seek a buyer by browsing the listings of buyer ads at step 516. If no potential buyer is found, the seller may post any items for sale as inventory items in the seller's database, as described above at step 502. If a potential buyer is found at step 518, the seller may offer the item at step 520. The offer is stored in the system at step 522, and an appropriate e-mail is generated automatically by the system and offered to the buyer at step 514 through the system's in-house e-mail system. The seller then waits for a response at step 508. The buyer may evaluate the seller's offer and respond accordingly through the system's in-house e-mail.

It will be understood that the Web pages shown in the drawings are representative examples only, and that details of the form and content of particular Web pages may very within the scope of the invention as described and claimed. The server scripts are preferably implemented in Perl or Active Server Page scrpts, but may be implemented in any other desired language, such a C, C++, Visual Basic, VBScript, JavaScript, etc. The database(s) described herein are relational databases, and the particular proprietary brand is not critical.

It is to be understood that the present invention is not limited to the embodiment described above, but encompasses any and all embodiments within the scope of the following claims.

1. A system for implementing a buyer driven transaction, comprising:
at least one server computer having a processor, an area of main memory for executing program code under the direction of the processor, a storage device for storing data and program code and a bus connecting the processor and the storage device;
at least one relational database stored on said storage device;
a data communications device connected to said bus for connecting said server computer to the Internet; and
Web-based computer program code stored in said storage device and executing in said main memory under the direction of said processor, the computer program having:
means for establishing a Web site on the Internet;
means for posting a buyer's ad on the Web site, the ad including a description of products or services wanted and a price therefor;
means for receiving a seller's offer in response to the buyer's ad;
means for generating an e-mail to the buyer communicating the seller's offer;
a seller's database storing inventories of products and services and prices therefor offered by a plurality of sellers;
means for automatically searching the seller's database for a match in the products or services and price therefor requested by the buyer before executing the means for posting the buyer's ad; and
means for displaying a Web page to the buyer for the match between the product or service requested by the buyer with the products and services in the seller's database.

2. The system according to claim 1, wherein said program code further comprises means for posting an item for sale in the seller's database.

3. The system according to claim 2, further comprising:
a buyer's database for storing a plurality of buyer's ads;
means for searching the buyer's database for a match in the products or services and price listed by the seller before executing the means for posting the item for sale in the seller's database; and
means for displaying a Web page to the seller for the match between item for sale and the buyer's ad stored in the buyer's database.

4. The system according to claim 3, further comprising:
means for publishing a treasure hunt form for receiving a seller's request for selling merchandise in a specified sum of money;
means for searching the buyer's database to match the sum specified by the seller against the buyers' ads;
means for displaying to the seller matches between the sum specified by the seller against the buyer's ads; and
means for communicating a seller's offer to sell merchandise described in the matching buyer's ad to the buyer.

5. The system according to claim 1, wherein the means for searching the seller's database includes means for browsing the database by category of products and services.

6. The system according to claim 1, wherein the means for searching the seller's database includes means for searching the seller's database by at least one specified search term.

7. A computerized method for implementing a buyer driven transaction through a Web site on a computer network, comprising the steps of:
establishing the Web site on the network;
posting a buyer's ad on the Web site, the ad including a description of products or services wanted and a price therefor;
receiving a seller's offer in response to the buyer's ad;
generating an e-mail to the buyer communicating the seller's offer;
automatically searching a seller's database of inventories of products and services and prices therefor for a match in the products or services and price therefor requested by the buyer before posting the buyer's ad; and
displaying a Web page to the buyer for the match between the product or service requested by the buyer with the products and services in the seller's database.

8. The method according to claim 7, further comprising the step of posting an item for sale in the seller's database.

9. The method according to claim 8, further comprising the steps of:
searching a buyer's database storing a plurality of buyer's ads for a match in the products or services and price listed by the seller before posting the item for sale in the seller's database; and
displaying a Web page to the seller for the match between item for sale and the buyer's ad stored in the buyer's database.

10. The method according to claim 9, further comprising the steps of:
publishing a treasure hunt form for receiving a seller's request for selling merchandise in a specified sum of money;
searching the buyer's database to match the sum specified by the seller against the buyers' ads;
displaying to the seller matches between the sum specified by the seller against the buyer's ads; and
communicating a seller's offer to sell merchandise described in the matching buyer's ad to the buyer.

11. The method according to claim 7, further comprising the step of searching the seller's database by category of products and services.

12. The method according to claim 7, further comprising the step of searching the seller's database by at least one specified search term.

13. A computer software product that includes a medium readable by a processor, the medium having stored thereon a set of instructions for implementing a buyer driven transaction on a Web site, comprising:
a first sequence of instructions which, when executed by the processor, causes said processor to establish a Web site on the Internet;
a second sequence of instructions which, when executed by the processor, causes said processor to post a buyer's ad on the Web site, the ad including a description of products or services wanted and a price therefor;
a third sequence of instructions which, when executed by the processor, causes said processor to receive a seller's offer in response to the buyer's ad;
a fourth sequence of instructions which, when executed by the processor, causes said processor to generate an e-mail to the buyer communicating the seller's offer;
a fifth sequence of instructions which, when executed by the processor, causes said processor to automatically searching a seller's database storing inventories of products and services and prices therefor for a match in the products or services and price therefor requested by the buyer before executing the means for posting the buyer's ad; and
a sixth sequence of instructions which, when executed by the processor, causes said processor to display a Web page to the buyer for the match between the product or service requested by the buyer with the products and services in the seller's database.

14. The computer software product according to claim 13, further comprising a seventh sequence of instructions which, when executed by the processor, causes said processor to post an item for sale in the seller's database.

15. The computer software product according to claim 14, further comprising:
an eighth sequence of instructions which, when executed by the processor, causes said processor to search a buyer's database storing a plurality of buyer's ads for a match in the products or services and price listed by the seller before posting the item for sale in the seller's database; and
an ninth sequence of instructions which, when executed by the processor, causes said processor to display a Web page to the seller for the match between item for sale and the buyer's ad stored in the buyer's database.

16. The computer software product according to claim 15, further comprising:
an tenth sequence of instructions which, when executed by the processor, causes said processor to publish a treasure hunt form for receiving a seller's request for selling merchandise in a specified sum of money;
an eleventh sequence of instructions which, when executed by the processor, causes said processor to search the buyer's database to match the sum specified by the seller against the buyers' ads;
a twelfth sequence of instructions which, when executed by the processor, causes said processor to display to the seller matches between the sum specified by the seller against the buyer's ads; and
a thirteenth sequence of instructions which, when executed by the processor, causes said processor to communicate a seller's offer to sell merchandise described in the matching buyer's ad to the buyer.

17. The computer software product according to claim 13, further comprising a fourteenth sequence of instructions which, when executed by the processor, causes said processor to search the seller's database by category of products and services.

18. The computer software product according to claim 13, further comprising a fifteenth sequence of instructions which, when executed by the processor, causes said processor to search the seller's database by at least one specified search term.
